(19) United States
(12) Patent Application Publication
(10) Pub. No.: US 2008/0032015 A1
(43) Pub. Date: Feb. 7, 2008

(54) Method of producing concentrated flour from wine grape pomace

(76) Inventor: Mark Walpole, Jordan Station (CA)

Correspondence Address: MILLER THOMSON LLP, 100 STONE ROAD WEST, SUITE 301, GUELPH, ON, N1G-5L3, US

(21) Appl. No.: 11/882,357

(22) Filed: Aug. 1, 2007

Related U.S. Application Data
(60) Provisional application No. 60/834,810, filed on Aug. 2, 2006.

(51) Int. Cl. A21D 6/00; A23L 1/212

(52) U.S. Cl. 426/473; 426/465

(57) ABSTRACT

A method for producing concentrated flour from wine grape pomace that includes obtaining an amount of wine grape pomace having moisture content from 50-80% and drying the wine grape pomace at a maximum 70° C. over a time period of 24-48 hours. Upon the completion of the drying step, the dried wine grape pomace is screened to remove stems, seeds and milled into flour through a 100 US mesh.

### FIELD OF THE INVENTION

This invention relates in general to producing fortified flour and more particularly to a method for producing concentrated flour from the pomace of different wine grape varietals.

### BACKGROUND OF THE INVENTION

During the process of wine making, there are a number of by-products namely the skins of the wine grapes and the seeds, which is called pomace. Traditionally the pomace was treated as a waste product and either composted or fed to livestock. In the past decade however there have been an increasing number of studies that have looked at the various benefits inherently found in the grapes. Many of these studies are due to the “French Paradox”, which is the observation of the inhabitants of France who have relatively low rates of coronary artery disease while consuming a diet high in saturated fats. One explanation is that the French have a higher consumption of red wine and therefore its health promoting compounds.

Some of the health promoting compounds found in wine have been identified as polyphenols (phenolic compounds) which have been found to exhibit powerful antioxidant properties. In general the polyphenols that are found in grapes include: proanthocyanins, anthocyanins, catechins (tannins), quercetin and trans-resveratrol. The antioxidant activity of these polypheonis can be measured using the ORAC method (oxygen radical absorption capacity).

Prior art methods involving extracting and analyzing grapes and their properties have been devised to explore some of these health promoting compounds, specifically polyphenols and their anti-oxidant properties have been the primary focus of these inventions. For example, ES Patent No. 2130092 relates to a process for obtaining natural antioxidant dietetic fibre in powder form from grapes, sub-products of vinification or elaboration of juice from grapes which present a high content of total dietetic fibre (65 to 80) and of associated bioactive compounds (15 to 25). During its preparation, only physical methods were used so as to preserve the biological activity of associated compounds. The anti-oxidizing activity of 1 g of these fibres expressed as the capacity of inhibition of the lipid oxidation and the capture of free radicals is equivalent to 200-400 mg and to 50-400 mg of vitamin E, respectively.

U.S. Patent Appln. No. 2005/0095332 which was published on May 5, 2005 to Stanely relates to procedures for deriving antioxidant phenolics from fruits and/or vegetables reliant upon milling to an aqueous slurry, subjection of the resultant aqueous phase to temperatures in the range of from 125° C. to 220° C. so as to derive in solution phenolics from the fruit and/or vegetable material, and thereafter some procedure of harvesting of the antioxidant phenolic composition. Such products in a powder, liquid concentrate or solution form are capable of being ingested for the purposes of ameliorating the health damaging effects of free radicals in the body, or being incorporated into food stuffs or cosmetics to act as antioxidants to prevent oxidative deterioration in the products such as the formation of off-flavours.

Mann is the owner of U.S. Patent Appln. No. 2002/0168429A1 which was published on Nov. 14, 2002. This patent relates to a method of delivering dietary supplements, in the form of intact anthocyanins, into the lower gastrointestinal tract of a body for absorption from an aqueous medium comprising: expressing juice from one or more fruits, which fruits include anthocyanins, thereby yielding a juice portion and a pomace portion; concentrating the juice portion to yield a juice concentrate; mixing the juice concentrate with the pomace portion; drying the juice-infused pomace to yield a free-flowing, non-hygroscopic powder formulation to yield the dietary supplement; and orally ingesting the dietary supplement in the form of capsules, tablets, shakes, drinks, energy supplements, energy bars, and the like.

U.S. Pat. No. 6,544,581 B1 which issued on Apr. 8, 2003 to Shrikhande et al. relates to a novel process for extraction, purification and concentration of polyphenol substances from whole grapes, grape seeds and grape pomace without the need for membrane filtration. Aspects of several embodiments of the novel processes include hot water extraction, a dual pH treatment of the hot water extracts, and the uses of a copolymer of trimethylolpropane trimethacrylate as an adsorbent resin to maximize the concentration and purification of the beneficial polyphenolic substances.

Howard is the owner of U.S. Pat. No. 6,238,673 B1 which issued on May 29, 2001. This patent relates to a method of producing a polyphenol-containing composition derived from grapes, the method including: preparing a liquid grape extract which includes polyphenols; contacting the liquid extract with a separation medium which fractionates the components of the extract; and recovering that fraction in which the polyphenols are present. Also disclosed is a method of enriching the composition with added flavonol.

Prior art methods however have not explored other health promoting compounds found in wine grapes such as essential fatty acids, high fibre, various minerals and vitamins, as well as an ability to extract these known and unknown health promoting compounds in a way that does not damage the compounds. Thus a method of producing concentrated flour from wine grape pomace which may be utilized in a wide variety of food stuffs while maintaining the viability of the health promoting compounds is desirable.

### SUMMARY OF THE INVENTION

An object of one aspect of the present invention is to provide an improved method for producing concentrated flour from wine grape pomace.

In accordance with one aspect of the present invention there is provided a method for producing concentrated flour from wine grape pomace that includes obtaining an amount of wine grape pomace having moisture content from 50-80% and drying the wine grape pomace. More specifically the wine grape pomace is placed in a drying facility and dried at a maximum 70° C. over a time period of 24-48 hours.

Conveniently, upon the completion of the drying step, the dried wine grape pomace is removed from the drying facility and screened to remove stems, seeds and any other undesirable objects. Finally the dried wine grape pomace may be milled on demand into flour through a 100 US mesh.

Preferably, the health promoting components include fibre, Omega-6 fatty acids, potassium, calcium, iron, and polyphenols such as proanthocyanins, anthocyanins, catechins (tannins), quercetin and trans-resveratrol.

Advantages of the present invention are: the viability of the health promoting compounds are not compromised during the method of producing the concentrated flour, the flour yields a high percentage of fibre, iron, potassium, calcium, essential fatty acids such as omega-6 polyunsaturated fat, is a source of energy, is low in saturated fat, is cholesterol, sodium, gluten and trans fat free, the process results in a flour with high palatability, a wide variety of wine grape varietals can be used which results in different flavours, colours and varying nutritional amounts, the process yields a flour with a sufficiently low moisture content that discourages bacteria and mold growth therefore providing improved shelf-life, numerous health benefiting components in available in one flour, low temperature and slow drying using a dehydrator ensures the integrity of the health promoting compounds, the flour may be used in a wide variety of markets such as baking, meat/poultry processing, dairy, beverage, dietary supplement and cosmetic/personal care markets; the flour may also be used as an ingredient in a wide variety of food products such as bakery products, pasta, dairy products such as cheese and yoghurt, beverages, as a flavouring, in pet food, and cosmetic products.

### DETAILED DESCRIPTION OF THE PREFERRED EMBODIMENT

In accordance with a preferred embodiment of the present invention there is provided a method of producing concentrated flour from wine grape pomace. The method includes obtaining an amount of wine grape pomace having a moisture content from 50-80% and drying the wine grape pomace. The wine grape pomace in general consists of wine grape skins, grape seeds, stems, and depending on the varietals of the wine grape pomace being used, wine grape pulp. Some varietals of wine grape pomace such as ice wine have very little wine grape pulp as the grapes are pressed to remove as much juice as possible and therefore there is very little wine grape pulp and the pomace has a lower moisture content. In contrast cabernet wine grape pomace has a higher moisture content as the wine grape skins are left with the juice during part of the wine making process and therefore the moisture content of the pomace is higher. The average moisture content in the wine grape pomace is 60%.

In general the wine grape pomace may have a number of health promoting components which if preserved through the heating and milling process, produces a flour having exceptional nutritional values. Specifically the health promoting components may include, fibre, Omega-6 fatty acids, potassium, calcium, iron, and polyphenols such as proanthocyanins, anthocyanins, catechins (tannins), quercetin and trans-resveratrol.

The wine grape pomace is placed in a drying facility and dried at a maximum 70° C. over a time period of 24-48 hours. In general the wine grape pomace is spread in a thin layer over a series of perforated racks that allow for air flow over, under and through the wine grape pomace. More specifically the drying facility may be a steam source dehydrator that allows for the relative humidity to be carefully controlled. By carefully controlling the heating of the wine grape pomace, the nutritional components in the wine grape pomace are not compromised.

In fact, a comparison of the impact of various temperatures (60° C., 100° C. and 140° C.) during the drying process has on the nutritional components in the wine grape pomace (namely, total extractable polyphenols (TEP), condensed tannins (CT) and antioxidant activity) indicated that at 60° C. that there was not a significant reduction in TEP activity, whereas at 100° C. and 140° C. there was significantly less TEP activity. This indicates that there is a deterioration of these compounds with the higher drying temperature. The CT content had similar ratios but also appeared to be more heat resistant as there was a more significant reduction in TEP activity than CT activity at the higher temperatures. It was also confirmed that antioxidant activity at low drying temperatures remained stable whereas at high temperatures antioxidant activity started to deteriorate. Therefore low temperature heating of the wine grape pomace is essential to ensure the integrity of the health promoting components.

However the temperature of the heating has to also be sufficient to deter the growth of bacteria or mold and the restarting of the fermentation process, but not too high so as to damage the natural nutritional components found in the wine grape pomace. Typically the range of temperature for heating is between 37° C.-70° C. The drying process may occur in a variety of facilities that allow for efficient, extended, low temperature and gentle drying, such as a dehydrator or kiln. Depending on the wine grape varietals being dried, the temperature during the process may be raised to 60° C. to kill any bacteria or mold similar to a pasteurization step. At the completion of the heating step, the moisture content in the wine grape pomace is typically less than 14%. Moisture content above 14% would be sufficient to allow for bacteria or mold growth.

Furthermore by allowing the wine grape pomace to dry slowly for a minimum of 24 hours to a maximum of 48 hours, the viability of the nutritional components is maintained. If the grape wine pomace is dried too quickly the grape wine pomace becomes brittle and not only loses its desired properties but also becomes difficult to handle in the remaining steps of the method. The length of time the wine grape pomace dries will depend on the type of wine grape varietals being dried and the moisture content as discussed above.

Upon the completion of the drying step, the dried wine grape pomace is removed from the drying facility and screened to remove stems, seeds and any other undesirable objects. Depending on the varietals being dried and screened, the seeds may or may not be present after screening. Typically red wine grape varietals have large seeds that may be screened away. White wine grape varietals typically have small seeds and as such the seeds are not screened out. Once the screening step is complete the wine grape pomace may be stored at this point or may proceed to the milling process.

The dried wine grape pomace may be milled on demand into flour through a 100 US mesh. Flour is generally defined as a standardized product made of wheat. It must have an ash content of less than 1.2% and a moisture content of less than 15%. There are specific nutrient requirements with respect to thiamine, riboflavin, niacin, folic acid and iron. It may also contain several other compounds contributing to the stability and functionality of the product. During the milling of the dried wine grape pomace, the moisture content is further reduced so that the resulting flour has a preferred moisture content of 10-11%. In general the milling results in an increase of the ambient temperature of 5° C. which drives off additional moisture in the dried wine grape pomace. It is important that frictional heating during the milling not reach temperatures where the natural nutritional components in the wine grape pomace will degrade.

The dried wine grape pomace may be milled through a range of mesh sizes namely 50 US, 100 US, 200 US to a maximum of 300 US. The wine grape pomace flour produced through a 50 US mesh is very fine and may be suspended in water. The wine grape pomace flour produced through a 100 US mesh has a preferred visual appearance as the hairy fiber from the wine grape skin is not visible and the flour has an even moisture absorption when in use. The visual appearance of the wine grape pomace flour will depend on the wine grape varietals being used. Wine grape pomace from red varietals produces dark coloured flour, whereas wine grape pomace from white varietals produces light coloured flour. The wine grape varietals used will also impact on the taste of the flour and the ultimate product the flour is used in. The wine grape pomace flour milled at 100 US mesh produces flour with high degree palatability and a pleasing taste.

The resulting wine grape pomace flour exhibits a number of exceptional nutritional properties that allow the flour to be used as an ingredient in a wide variety of food products, pet food and cosmetic markets. Some of the nutritional properties found in 100 g of wine grape pomace flour made from the disclosed method are the following:

| Amount | |
|---|---|
| Calories 380 | % Daily Value |
| Fat 6 g | 9% |
| Saturated 1 g | 5% |
| Trans 0 g | |
| Polyunsaturated 4 g | |
| Omega-6 64 g | |
| Omega-3 30.2 g | |
| Monounsaturated 1 g | |
| Cholesterol 0 mg | 0% |
| Sodium 0 mg | 0% |
| Potassium 2100 mg | 60% |
| Carbohydrate 69 g | 23% |
| Fibre 52 g | 208% |
| Sugars 5 g | |
| Protein 12 g | |
| Vitamin A | 8% |
| Vitamin C | 0% |
| Calcium | 70% |
| Iron | 710% |

The wine grape pomace flour produced through the method described above results in flour with exceptionally high fibre, Omega-6 fatty acids, potassium and iron. The wine grape pomace flour also does not contain any cholesterol, gluten, sodium or trans fats. As such the flour may be used as an ingredient or supplement in wide variety of food products while imparting the noted advantages. Specifically the use of high fibre products have been known to reduce blood pressure, blood sugar, cholesterol levels and triglycerides. Potassium is also known to aid in weight loss, while iron has impact on anemia and is beneficial for the elderly. These health promoting compounds are therefore imparted in a single ingredient that can easily be substituted into recipes and ingredient lists. Areas and uses where the wine grape pomace may be found are baking, meat/poultry processing, beverage, dietary supplements and personal care markets, pasta, dairy products such as cheese and yoghurt, flavourings, in pet food, and cosmetic products.

The nutritional values for the flour from the wine grape pomace will vary depending on the wine grape varietals being processed. Typically the white wine varietals have higher health promoting compounds as the grape skins are not left in the grape juice during the fermentation process unlike the wine making process for red wine, where the grape skins are left in the grape juice so as to add colour to the resulting red wine. A comparison of the various health promoting compounds found in both red and white wine and in regular bread are as follows:

| | ORAC_{hydro} | | |
|---|---|---|---|
| Sample ID | (1 moleTE/g) | Phenolics | Anthocyanin |
| White Wine | 354 | 27.79 | Not Detected |
| Blend | | | |
| Red Wine Blend | 190 | 16.97 | 0.86 |
| Bread | 10 | 0.81 | Not Detected |

*The ORAC analysis provides a measure of the scavenging capacity of antioxidants against the peroxyl radical, which is one of the most common reactive oxygen species (ROS) found in the body. ORAC_{hydro} reflects water-soluble antioxidant capacity. Trolox, a water-soluble Vitamin E analog, is used as the calibration standard and the ORAC result is expressed as micromole Trolox equivalent (TE) per gram. The phenolic result is expressed as milligram gallic acid equivalent per gram. The anthocyanin result is expressed as milligram cyanidine-3-glucoside equivalent per gram. The acceptable precision of the ORAC assay is 15% relative standard deviation.

The wine grape pomace flour produced through the method described above results in flour with these health promoting compounds as the method is non-aggressive and does not destroy these components during the heating and milling steps. As noted above, the amount of health promoting compounds will depend on the wine grape varietals being used. As such a product using the flour from a white wine grape pomace will have higher health promoting compounds than a product using the red wine grape pomace flour. Example 1 discloses by way of example only a bread formulation using the wine grape pomace flour to make bread.

### EXAMPLE 1

A par-baked, frozen bread formulation was developed using the flour from the wine grape pomace as an ingredient as shown in Table 1:

TABLE 1
Frozen and Par-Baked Formulation

| | Bakers % | % |
|---|---|---|
| Wheat Flour | 90 | 52.94% |
| Wine Grape Pomace | 10 | 5.88% |
| Flour | | |
| Water | 62 | 36.47% |
| Yeast | 2.6 | 1.53% |
| Salt | 2 | 1.18% |
| Oil | 2 | 1.18% |
| Ascorbic Acid | * | * |
| Vital wheat gluten | 1.4 | 0.82% |
| 80°/ | | |

* ascorbic acid is added at a level of 120 mg/kg, below the 200 ppm regulated level. This is calculated as 0. 120 * (total mass of formulation in kg) in grams.

### EXAMPLE 2

A dry mix was developed for use in a bread machine, to be sold to consumers as a premix. Dry ingredients were blended to make the bread machine dry mix. Based on the bread machine instructions, wet ingredients were first added, followed by the dry mix. The formula is set out in Table 2:

TABLE 2
Consumer Bread Machine Recipe

| | | | 2 lb. |
|---|---|---|---|
| | Bakers % | batch (g) | Loaf |
| Water | 67.35% | 37.06% | 330.00 |
| Yeast (rapid | 0.92% | 0.51% | 4.50 |
| rise) | | | |
| Shortening | 4.08% | 2.25% | 20.00 |
| Wheat flour | 90.82% | 49S~7% | 445.00 |
| Wine Grape | 9.18% | 5.05% | 45.00 |
| Pomace Flour | | | |
| Salt | 1.78% | 0.9~% | 8.70 |
| Sugar | 2.65% | 1.46% | 13.00 |
| Powdered milk | 3.67% | 2.02% | 18.00 |
| Vital gluten | 1.29% | 0.71% | 6.30 |
| 80% | | | |
| | 181.73% | 100.00% | 890.50 |

### Baking on basic bread setting (3 hour 50 minutes), regular crust Tested using Black and Decker All-In-One Deluxe Automatic Bread maker

Other variations and modifications of the invention are possible. All such modifications or variations are believed to be within the sphere and scope of the invention as defined by the claims appended hereto.

1. A method for producing concentrated flour from wine grape pomace comprising:
(a) obtaining an amount of wine grape pomace having moisture content from 50-80%, and
(b) drying the wine grape pomace.

2. A method for producing concentrated flour from wine grape pomace as claimed in claim 1 wherein the wine grape pomace consists of a combination of wine grape skins, grape seeds, stems and wine grape pulp.

3. A method for producing concentrated flour from wine grape pomace as claimed in claim 1 further comprising drying the wine grape pomace at a maximum of 70° C.

4. A method for producing concentrated flour from wine grape pomace as claimed in claim 1 further comprising drying the wine grape pomace a minimum of 37° C.

5. A method for producing concentrated flour from wine grape pomace as claimed in claim 1 further comprising drying the wine grape pomace over a minimum time period of 24 hours.

6. A method for producing concentrated flour from wine grape pomace as claimed in claim 1 further comprising drying the wine grape pomace over a maximum time period of 48 hours.

7. A method for producing concentrated flour from wine grape pomace as claimed in claim 1 wherein the drying of the wine grape pomace is conducted in a steam source dehydrator.

8. A method for producing concentrated flour from wine grape pomace as claimed in claim 1 wherein the drying of the wine grape pomace is conducted in a kiln.

9. A method for producing concentrated flour from wine grape pomace as claimed in claim 1 wherein the drying of the wine grape pomace removes bacteria and mold.

10. A method for producing concentrated flour from wine grape pomace as claimed in claim 1 wherein the drying of wine pomace produces a shelf stable dried grape pomace.

11. A method for producing concentrated flour from wine grape pomace as claimed in claim 7 further comprising of spreading the wine grape pomace in a thin layer on perforated racks.

12. A method for producing concentrated flour from wine grape pomace as claimed in claim 1 further comprising screening the dried wine pomace to remove stems, seeds and any undesirable object.

13. A method for producing concentrated flour from wine grape pomace as claimed in claim 12 further comprising milling the screened, dried wine pomace.

14. A method for producing concentrated flour from wine grape pomace as claimed in claim 13 wherein the wine pomace is milled through a mesh between 50 to 300 US to produce a flour.

15. A method for producing concentrated flour from wine grape pomace as claimed in claim 13 wherein milling the dried wine pomace through a 50 US mesh produces a fine flour for suspension in a liquid.

16. A method for producing concentrated flour from wine grape pomace as claimed in claim 13 wherein milling the dried wine pomace through a 100 US mesh produces a flour having even moisture absorption and high palatability.

17. A method for producing concentrated flour from wine grape pomace as claimed in claim 13 wherein the concentrated flour has a moisture content less than 15%.

18. A method for producing concentrated flour from wine grape pomace as claimed in claim 13 wherein the milling of the dried wine pomace produces a flour with a moisture content between 10 and 11%.

19. A method for producing concentrated flour from wine grape pomace as claimed in claim 1 wherein the concentrated flour comprises high fibre, essential fatty acids, potassium and iron.

20. A method for producing concentrated flour from wine grape pomace as claimed in claim 1 wherein does not contain any cholesterol, gluten, sodium or trans fats.
